(19) United States
(12) Patent Application Publication
(10) Pub. No.: US 2007/0140171 A1
(43) Pub. Date: Jun. 21, 2007

(54) Radio link management in distributed network architecture

(75) Inventor: Srinivasan Balasubramanian, San Diego, CA (US)

Correspondence Address: COATS & BENNETT, PLLC, 1400 Crescent Green, Suite 300, Cary, NC, 27518, US

(73) Assignee: Telefonaktiebolaget LM Ericsson (publ)

(21) Appl. No.: 11/304,841

(22) Filed: Dec. 15, 2005

(51) Int. Cl. H04Q 7/00

(52) U.S. Cl. 370/331; 370/338

(57) ABSTRACT

In a mobile communication network, the call context for an active call is managed in a distributed manner following a cell change. When a mobile station migrates from one access node (AN) to another during the course of a call, the call state variables are transferred to the new serving AN. Additionally, a mapping table is transferred to the new serving AN indicating the location of buffered data. The mapping table reduces the amount of data that needs to be transferred to the new serving AN.

### BACKGROUND

The present invention relates generally to high speed packet data communications in CDMA systems and, more particularly, to radio link management in a CDMA mobile communication network having a distributed architecture.

The radio link protocol (RLP) is used in a mobile communication network to reduce the error rate over the radio channels. Through the use of forward error correction and retransmission protocols, the physical layer can deliver packets with an error rate on the order of 1%. For most packet data services, a lower error rate is needed since most data applications are sensitive to packet loss. If the applications are delay tolerant, the radio link protocol (RLP) can be used to further reduce the error rate of the radio channel. RLP is a NACK-based retransmission protocol that divides a data stream into packets for delivery over the radio channel. If a packet is missed at the receiver, the receiver can request retransmission of the missing packet. At the transmitter, transmitted packets are temporarily stored in a retransmit buffer to enable retransmission of missing packets. At the receiver, the received packets are temporarily stored in a resequencing buffer prior to delivery to higher layer protocols. Once a complete data block is received, the data block is forwarded by the receiver.

The RLP context, or call context, is typically managed by a centralized RLM controller. For example, the RLM controller may be part of an access network controller that performs radio link management for a plurality of base stations. However, high speed packet data networks are evolving toward a distributed architecture in which each base station includes its own local access network controller that performs radio link management for the base station.

In networks employing a distributed architecture, the RLP context or call context, may need to be transferred when the mobile station moves between cells, or a new RLP context must be established. Transferring the- RLP context between base stations when the mobile station moves between cells significantly increases traffic on the sidehaul links between the base stations. On the other hand, establishing a new RLP context at the target base station results in data loss.

### SUMMARY

The present invention provides a method for transferring RLP context, or call context, between two access nodes (ANs) in a mobile communication network. When a mobile station moves between two cells in a network, the RLP state variables are transferred from the prior serving AN to the new serving AN. However, the data stored in the retransmit or resequencing buffers is not transferred. Instead, a mapping table indicating the data stored at each prior serving AN is transferred to the new serving AN. If the new serving AN receives a NACK of a packet stored in a prior serving AN, the new serving AN uses the mapping table to determine the location of the packet and sends a request to the prior serving AN for the missing packet. After receiving the packet from the prior serving AN, the new serving AN retransmits the packet. When the new serving AN receives a packet not in the range of sequence numbers that are stored locally, the new serving AN uses the mapping table to determine a forwarding location for the packet. The new serving AN then sends the packet over the sidehaul to the prior serving AN. The mapping table therefore avoids the need to transfer the entire contents of the retransmit and resequencing buffers when the call context is transferred.

### BRIEF DESCRIPTION OF THE DRAWINGS

FIG. 1 illustrates an exemplary mobile communication network.

FIG. 2 illustrates logical elements in an exemplary access network for a mobile communication network.

FIG. 3 illustrates the structure of an exemplary RLP packet.

FIG. 4 illustrates an exemplary method for managing the RLP context for forward link communications.

FIG. 5 illustrates an exemplary method for managing the RLP context for reverse link communications.

FIG. 6 illustrates an exemplary procedure implemented by the serving AN for NACK processing.

FIG. 7 illustrates an exemplary procedure implemented by the serving AN for processing received RLP packets.

### DETAILED DESCRIPTION

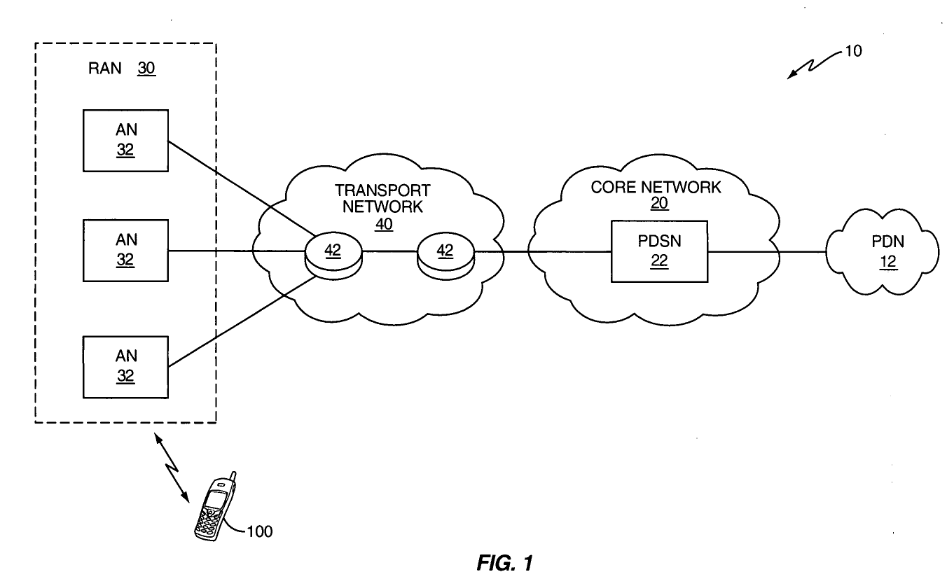

FIG. 1 illustrates an exemplary high-rate packet data (HRPD) network 10 according to one embodiment of the invention providing wireless packet data services to a plurality of mobile stations 100. Communication network 10 has a distributed rather than centralized architecture. Mobile communication network 10 comprises a packet-switched core network 20 including a Packet Data Serving Node (PDSN) 22, and a radio access network 30 comprising one or more access nodes (ANs) 32. An IP-based transport network 40 comprising one or more routers 42 connects the core network 20 with the RAN 30. The PDSN 22 connects to an external packet data network (PDN) 12, such as the Internet, and supports PPP connections to and from the mobile stations 100. The PDSN 22 adds and removes IP streams to and from the ANs 32 and routes packets between the external packet data network 12 and the ANs 32. The ANs 32 provide the connection between the mobile stations 100 and the core network 20. Each AN 32 provides coverage in a corresponding cell. In the exemplary embodiment, one cell also comprises a packet zone.

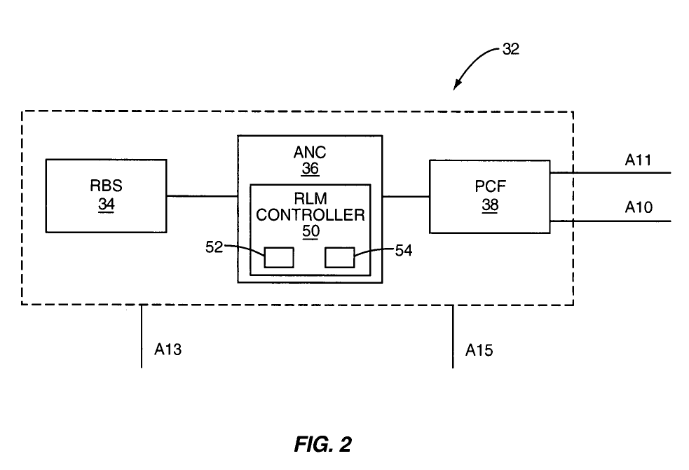

FIG. 2 illustrates the logical elements of an exemplary AN 32. The AN 32 comprises a radio base station (RBS) 34, an access network controller (ANC) 36, and a Packet Control Function (PCF) 38. The RBS 34 includes the radio equipment for communicating over the air interface with mobile stations 100. The ANC 36 controls the operation of the AN 32. AN 32 manages radio resources allocated to the AN 32, handles Layer 3 signaling, and performs radio link management (RLM) functions as hereinafter described. The PCF 38 establishes, maintains, and terminates connections from the AN 32 to the PDSN 22. AN 32 communicates over A13 and A15 communication links with other ANs 32. The A13 interface is used to transfer session information and call context between ANs 32. The A15 interface is used for inter-AN paging.

Between the AN 32 and the PDSN 22, the packet data and signaling data travel over the A10 and A11 communication links respectively. Generic Routing Encapsulation (GRE) is used to transport data over the A10 communication link. GRE is a well-known protocol for encapsulation of an arbitrary network layer protocol over another arbitrary network layer protocol. The ANs 32 may operate, for example, according to the Telecommunications Industry Association (TIA) standard TIA-856-A, which defines an air interface between the AN 32 and mobile stations 100. Those skilled in the art will appreciate that the present invention may also use in other air interface standards, such as TIA-2000 and the emerging Wideband CDMA standard.

During operation, the mobile station 100 establishes a point-to-point (PPP) session with the PDSN 22. During the session establishment, a radio-packet (R-P) connection is established between the PDSN 22 and the AN 32 to provide a transmission path for the user data and signaling between the PDSN 22 and the AN 32. The R-P connection includes the A10 connection for user data and the A11 connection for signaling data. In one exemplary embodiment, the PDSN 22 interfaces with the PCF 38 in the AN 32 by setting up a GRE tunnel. After establishing a PPP session, the mobile station 100 can transmit and receive packet-data. The mobile stations 100 are typically assigned a Unicast Access Terminal Identifier (UATI) by one of the ANs 32 during session establishment. The UATI serves as a temporary identifier to identify the mobile station 100 during the session and is included in air interface messages.

CDMA networks based on the TIA/EIA-856A standard use the Radio Link Protocol (RLP) to provide improved error performance on the radio link needed for reliable communication over Transmission Control Protocol (TCP) networks such as the Internet. Typically, Hybrid ARQ is employed at the physical layer to provide an error rate of approximately one percent (1%.) TCP, however, requires an error rate in the order of 10-4 for reliable communications. RLP bridges the gap between the error performance of the radio channel and the requirements for reliable communication over TCP networks.

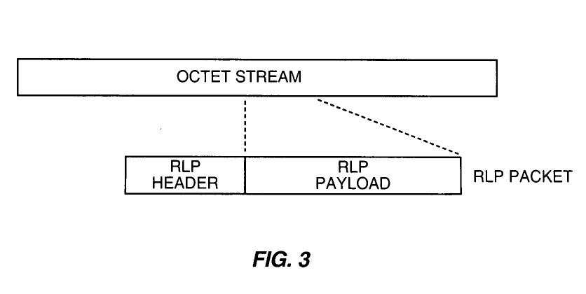

RLP provides transport for PPP packets over forward and reverse packet data channels. RLP is unaware of higher level framing. RLP divides the higher layer frames into octets and delivers the octet stream over the radio channel as shown in FIG. 3. Each octet in the higher layer stream is inserted into the payload of an RLP packet, and an RLP header is added. RLP reduces the error rate of the radio channel using a NACK-based retransmission protocol. Whenever a missing RLP packet is detected, the receiver sends a NACK indicating the sequence number of the missing RLP packet to the transmitter. The transmitter retransmits the missing RLP packet. Conventionally, up to two retransmissions are allowed. However, those skilled in the art will recognize that the number of retransmissions allowed may be selected to optimize overall system throughput.

Radio link management (RLM) is a function of the ANC 36. To perform this function, the ANC 36 includes an RLM controller 50 (FIG. 2) to ensure that RLP packets are delivered. The RLM controller 50 uses a retransmit buffer 52 and a re-sequencing buffer 54 to temporarily store RLP packets. The retransmit buffer 52 temporarily stores RLP packets transmitted by the AN 32 to the mobile station 100 over the air interface in case the packets need to be retransmitted. The re-sequencing buffer 54 temporarily stores RLP packets received from a mobile station 100 until complete data blocks can be assembled. When a complete data block is received, the data block is then forwarded to the PDSN 22. The RLM controller 50 manages both buffers 52, 54. To perform its management role, the RLM controller 50 maintains several state variables that describe the call state. The state variables include the sequence number V(s) of the next RLP packet to be sent, the sequence number V(r) of the next octet expected to arrive, and the sequence number V(n) of the first missing octet. The state variables may further include an estimate V(n)ₚₑₑᵣ of the first missing packet at a peer AN 32. The RLP context, or call context, includes the buffer contents and the value of the RLP state variables. RLP is described in the 3GPP2 standard “Data Service Options for Spread Spectrum Systems: Radio Link Protocol Type 3, C.S007-010-A (September 2005).

In a network 10 with a distributed architecture as shown in FIG. 1, the mobile station 100 will frequently move between ANs 32 during the course of a call. When the mobile station 100 moves between ANs 32 during a call, the network 10 must either route packets from an anchor AN 32 (the AN maintaining the A10 connection to the PDSN 22) to the serving AN 32 over a sidehaul, or transfer the A10 connection to the serving AN 32. In a distributed network architecture, the first option would greatly increase the amount of traffic on the sidehaul links between neighboring ANs 32. The second option requires that the call context and session information be transferred from the anchor AN 32 to the new serving AN 32. The new serving AN 32 then becomes the anchor AN 32 for the call.

The present invention provides an efficient method of transferring the call context from one AN 32 to another with low overhead following a cell reselection. According to the present invention, the A10 connection is transferred from the prior serving AN 32 to a new serving AN 32 in response to a cell reselection by the mobile station 100. The new serving AN 32 sets up an A10 connection to the PDSN 22 and becomes the anchor AN 32 for the session. While an A10 connection with the PDSN 22 is being established by the new serving AN 32, both the session information and call context are transferred to the new serving AN 32. The session information includes the set of protocols used by the mobile station 100 to communicate over the air interface with the AN 32, and configuration settings for those protocols (e.g., authentication keys, parameters for Connection Layer and MAC Layer protocols, etc.). The call context includes the RLP state variables and the buffer content. In one exemplary embodiment, the RLP state variables are transferred from the prior serving AN 32 to the new serving AN 32 responsive to changing cells. The content of the retransmission and re-sequencing buffers 52, 54 could also be transferred to the new serving AN 32. For most best-effort services, however, traffic on the sidehaul between ANs 32 can be significantly reduced by transferring a mapping table from the source AN 32 to the target AN 32 instead of the buffered data in response to a cell reselection.

The mapping table is a table that indicates the range of data by sequence number stored in each of the previous serving ANs 32. The range of data maintained by a particular AN 32, whether it is the current serving sector or a prior serving sector, is referred to herein as the local call context. The range of date sequence numbers stored by all of the ANs 32 is referred to herein as the global context. In the case of the forward link communications, the mapping table indicates to the current serving AN 32 the range of data stored by each of the prior serving ANs 32 in their respective retransmission buffers 52. In the case of the reverse link communications, the mapping table indicates to the new serving AN 32 the range of data by sequence number held in the re-sequencing buffer 54 for each of the prior serving ANs 32.

If the mobile station 100 sends a retransmission request for an RLP packet stored by a prior serving AN 32, which is outside of the local context of the serving AN 32, the serving AN 32 can request the RLP packet from a prior serving AN 32. When a packet is received from the mobile station 100 at the current serving AN 32 with a sequence number outside local context of the serving AN 32, the serving AN 32 may forward the packet to a prior serving AN 32. Thus, the buffered data is distributed among several ANs 32. A peer-to-peer signaling protocol over the A13 link can be used to notify the current serving AN 32 of any changes in the retransmission and re-sequencing buffers 52, 54 at the prior serving ANs 32 so that the mapping table can be updated accordingly.

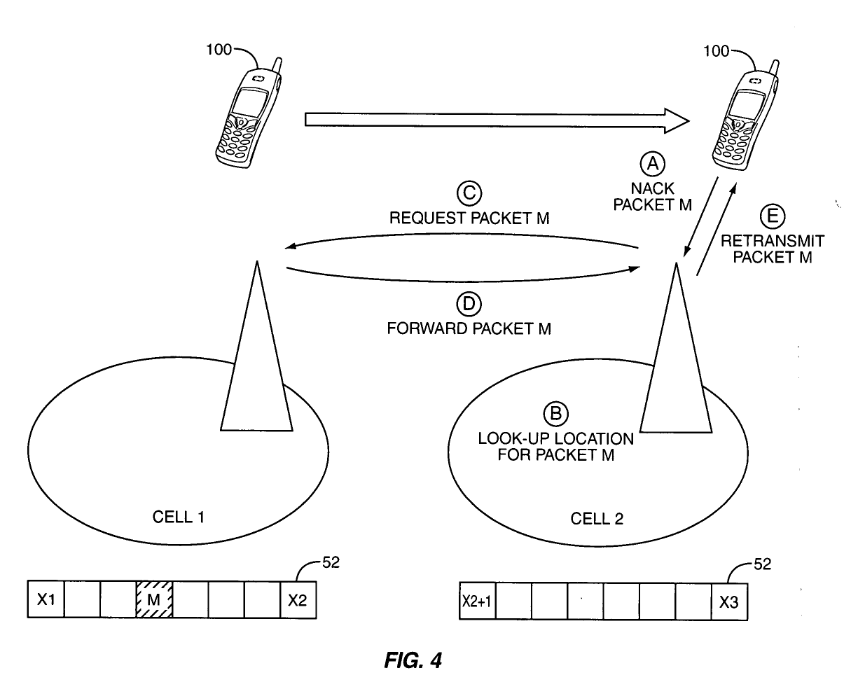

FIG. 4 illustrates how the mapping table is used to manage the RLP context for forward link communications. In the example shown in FIG. 4, the mobile station 100 began communication with AN1 in cell 1. AN1 transmits packets with sequence numbers X1 to X2. After packet X2 is transmitted, the mobile station 100 switches to AN2 in cell 2 which transmits packets with sequence numbers X2+1 to X3. While AN2 is the serving AN 32, the mobile station 100 NACKS packet M where X1<M<X2 (step A). Because packet M is outside the range of sequence numbers maintained by AN2, AN2 accesses the mapping table to determine that AN1 has packet M stored in its retransmit buffer 52 (step B). AN2 sends a request for packet M to AN1 over a sidehaul link (step C). AN1 sends the requested packet to AN2 (step D). After receiving the requested packet from AN2, AN1 retransmits the packet to the mobile station 100 (step E).

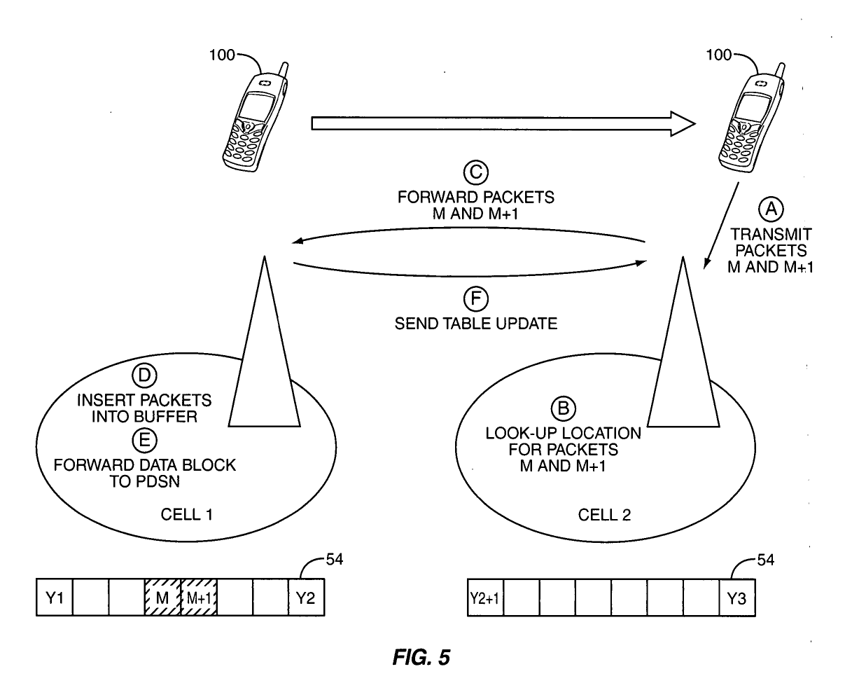

FIG. 5 illustrates how the mapping table is used to manage the RLP context for reverse link communications. In this example, it is assumed that the serving AN 32 performs selection combining for reverse link communications. The mobile station 100 begins reverse link communications with AN1 in cell 1. While AN1 is the serving AN 32, the mobile station 100 transmits packets Y1 to Y2. The packets with sequence numbers M and M+1 between Y1 and Y2 are lost. The mobile station 100 subsequently switches to AN2 in cell 2. While AN2 is the serving AN 32, the mobile station 100 sends packets with sequence numbers Y2+1 to Y3. Subsequently, AN2 receives packets M and M+1 from the mobile station 100 (step A). Since these packets are outside the range of data maintained in the re-sequencing buffer 54 at AN2, it accesses the mapping table to determine the peer AN 32 to which the received packets should be forwarded (step B). The mapping table indicates that packets M and M+1 should be forwarded to AN1. AN2 forwards the received packets to AN1 (step C). After receipt of the packets M and M+1 at AN1, the missing packets are inserted into the re-sequencing buffer 54 (step D) and the completed data block is forwarded to the PDSN (step E). Since the re-sequencing buffer 54 is cleared at AN1, AN1 sends a table update message to AN2 (step F) so that AN2 can update the mapping table to reflect that AN1 no longer has any data in its re-sequencing buffer 54.

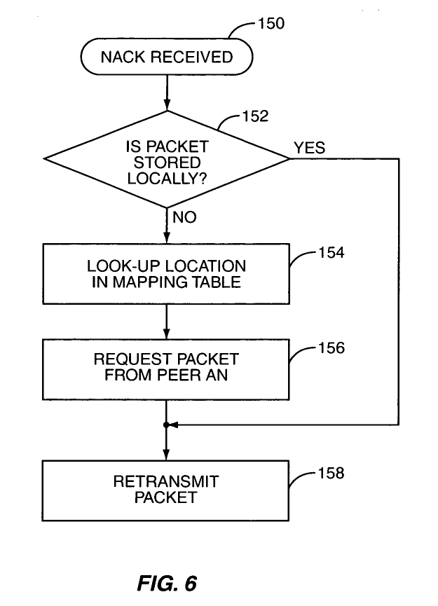

FIG. 6 illustrates exemplary NACK processing by the serving AN 32. When a NACK is received (block 150), the RLM controller 50 for the serving AN 32 determines whether the packet identified by the NACK is stored in local memory (block 152). If so, the serving AN 32 retransmits the packet (block 158). If not, the serving AN 32 looks up the location of the packet specified by the NACK in the mapping table (block 154), and sends a request for the packet to the identified peer AN 32 (block 156). After receiving the requested packet from the peer AN 32, the anchor AN 32 retransmits the packet to the mobile station 100 (block 158).

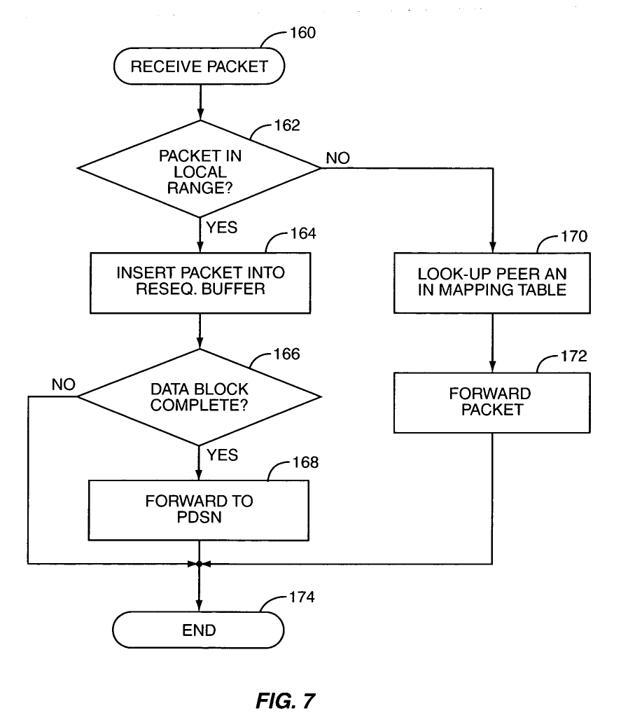

FIG. 7 illustrates an exemplary procedure implemented by the serving AN 32 for processing packets received from a mobile station 100 on a reverse link. When a packet is received (block 160), the serving AN 32 determines if the packet is in the range of its local re-sequencing buffer 54 (block 162). If so, the serving AN 32 inserts the packet into the re-sequencing buffer 54 (block 164) and determines whether it has a complete data block (block 166). If the received packet completes a data block, the serving AN 32 forwards the data block to the PDSN 22 (block 168), and the procedure ends (block 174). If the packet is outside the range of the local re-sequencing buffer 54, the serving AN 32 looks up the peer AN 32 to which the packet should be forwarded in the mapping table (block 170), and forwards the packet to the peer AN 32 (block 172).

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented by a source access node in a mobile communication network of supporting cell reselection by a mobile station moving between cells while said mobile station is in an active call, said method comprising:
maintaining the call context for a mobile station engaged in an active call; and
transferring the call context stored in said source access node to a target access node.

2. The method of claim 1 wherein maintaining the call context for an active call comprises:
maintaining call state variables indicative of the call state; and
buffering data transmitted to and received from said mobile station during said active call;

3. The method of claim 2 wherein transferring the call context to said target access node comprises:
sending said call state variables for said call from said source access node to said target access node; and
sending a mapping table indicating the buffered data stored at the source access node.

4. The method of claim 3 further comprising:
receiving a request from said target access node for a forward link packet stored at said target access node; and
forwarding the requested packet to the target access node.

5. The method of claim 4 further comprising:
receiving a reverse link packet at said source access node from said target access node;
forwarding said reverse link packet to a packet data serving node.

6. An access node for a mobile communication network comprising:
a radio access node for communicating with a mobile station;
an access network controller connected to said radio access node, said access network controller operative to:
store the call context for an active call;
transfer the call context to a target access node.

7. The access node of claim 6 wherein the call context for an active call comprises call state variables indicative of the call state, and buffered data transmitted to and received from said mobile station during said active call.

8. The access node of claim 7 wherein the access network controller transfers the call context to said target access node by sending said call state variables for said call from said source access node to said target access node, and by sending a mapping table indicating the buffered data stored at the source access node.

9. The access node of claim 8 wherein the access network controller is further operative to receive a request from said target access node for a forward link packet stored at said target access node, and to forward the requested packet to the target access node.

10. The access node of claim 9 wherein the access network controller is further operative to receive a reverse link packet at said source access node from said target access node, and to forward said reverse link packet to a packet data serving node.

11. A method implemented by a target access node in a mobile communication network of supporting cell reselection by a mobile station moving between cells while said mobile station is in an active call, said method comprising:
receiving an indication from a mobile station engaged in an active call that the target access node has been selected as the serving access node;
requesting the call context for the call from a source access node; and
receiving the call context from the source access node.

12. The method of claim 1 1 wherein receiving the call context from the source access node comprises receiving call state variables indicative of the call state, and receiving a mapping table indicating call data buffered at the source access node.

13. The method of claim 12 further comprising:
receiving a retransmission request from said mobile station for a forward link packet buffered by a prior serving access node;
sending a transfer request to said prior serving access node for said forward link packet; and
receiving the forward link packet from the prior serving access node; and
sending the forward link packet to the mobile station.

14. The method of claim 13 further comprising:
receiving a reverse link packet from said mobile station outside the local context maintained by the target access node; and
forwarding said reverse link packet data to a prior serving access node.

15. An access node for a mobile communication network comprising:
a radio base station for communicating with a mobile station;
an access network controller connected to said radio base station, said access network controller operative to:
receive an indication from a mobile station engaged in an active call that the target access node has been selected as the serving access node;
request the call context for the call from a prior serving access node; and
receive the call context from the prior serving node.

16. The access node of claim 15 wherein the call context received from the prior serving access node includes call state variables indicative of the call state, and a mapping table indicating call data buffered by said prior serving access node.

17. The access node of claim 16 wherein the access network controller is further operative to:
receive a retransmission request from said mobile station for a forward link packet buffered by said prior serving access node;
send a transfer request to said prior serving access node for said forward link packet; and
receive the forward link packet from the prior serving access node; and
send the forward link packet to the mobile station.

18. The access node of claim 16 wherein the access network controller is further operative to:
receive a reverse link packet from said mobile station outside the local context maintained by the access node; and
forward said reverse link packet data to a prior serving access node.
